(19) United States
(12) Patent Application Publication
(10) Pub. No.: US 2007/0141414 A1
(43) Pub. Date: Jun. 21, 2007

(54) Fuel cell having micro sensors

(76) Inventors: Shuo-Jen Lee, Taipei City (TW); Chi-Yuan Lee, Lujhu Township (TW); Yu-Ming Lee, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/410,894

(22) Filed: Apr. 26, 2006

(30) Foreign Application Priority Data
Dec. 19, 2005 (TW) 094145111

(51) Int. Cl. H01M 8/04; H01M 8/02

(52) U.S. Cl. 429/22; 429/38

(57) ABSTRACT

A fuel cell having micro sensors is disclosed. It has a pair of bipolar plates and a catalytic portion. About each bipolar plate, it has an inner surface and an outer surface. There are a fluid inlet, a fluid outlet, a channel, one or more micro sensors and several signal lines disposed on this inner surface. This catalytic portion is disposed between two bipolar plates. So, it can detect the actual internal conditions in the fuel cell. There is no need to install extra micro sensors. And, the fuel cell stability and safety can be enhanced significantly.

### BACKGROUND OF INVENTION

1. Field of the Invention

The present invention relates to a fuel cell. Particularly, it relates to a fuel cell having micro sensors that can detect its internal conditions without mounting extra sensors. It can detect the actual internal conditions in the fuel cell. There is no need to install extra micro sensors. The fuel cell stability and safety can be enhanced significantly.

2. Description of the Prior Art

Referring to FIGS. 1 and 2, the conventional fuel cell includes a pair of bipolar plates 10 and a catalytic portion 20. Each bipolar plate 10 comprises:

(a) a fluid inlet 11;

(b) a fluid outlet 12; and

(c) a channel 13 disposed on the bipolar plate 10 and connected with this fluid inlet 11 and the fluid outlet 12. Usually, this channel 13 consists of many snake-like curvy sections.

Concerning this catalytic portion 20, it is disposed between the bipolar plates 10.

The problems of the conventional fuel cell can be summarized as follows.

[1]. It cannot detect the internal conditions in the fuel cell. For most prior arts in this field, it is hard to detect the internal conditions inside the fuel cell because there is no any micro sensor inside. Thus, it is impossible to measure the actual conditions (like temperature, humidity, has pressure, etc.).

[2]. It is required to install micro sensors. For some prior arts, two thermal detectors and/or two tiny pressure gauges are mounted near the fluid inlet and fluid outlet respectively. By using them, the conditions at the entering and leaving points of the channel can be measured. However, it is hard to understand the actual temperature distribution or pressure distribution inside (such as a specific point in this channel). Besides, it is more complicated (and cost more) to install extra micro sensors on the existing bipolar plates. Thus, it is hard to detect the internal conditions in the channel of the fuel cell.

[3]. The overall fuel cell stability and safety are relatively low. Without installing these micro sensors, it is impossible to know the actual conditions inside the fuel cell. Furthermore, it is impossible to precisely control the temperature, humidity, pressure and other factors of the working fuel cell. Therefore, the fuel cell's stability and safety are relatively low.

### SUMMARY OF THE INVENTION

The object of the invention is to provide a fuel cell having micro sensors that can detect the internal conditions in the fuel cell.

The other object of the invention is to provide a fuel cell having micro sensors. In which, there is no need to install extra micro sensors.

The further object of the invention is to provide a fuel cell having micro sensors. Its fuel cell stability and safety can be enhanced significantly.

The above objects are achieved according to this invention by providing a fuel cell having micro sensors comprising:
a pair of bipolar plates, each bipolar plate having an inner surface and an outer surface, said inner surface being disposed with a fluid inlet, a fluid outlet, a channel connecting said fluid inlet and said fluid outlet, at least one sensor, and at least one signal line; and
a catalytic portion between said bipolar plates.

### BRIEF DESCRIPTION OF THE DRAWINGS

FIG. 1 is a perspective view showing the conventional fuel cell when it is disassembled.

FIG. 2 is a cross-sectional view in a selected portion of the conventional fuel cell.

FIG. 3 is a top view for one bipolar plate of the present invention.

FIG. 4 is a cross-sectional view of the present invention.

FIG. 5 illustrates an example having several well-embedded micro sensors in the present invention.

FIG. 6 is a cross-sectional view showing another preferred embodiment of the present invention.

### DETAILED DESCRIPTION OF THE PREFERRED EMBODIMENT

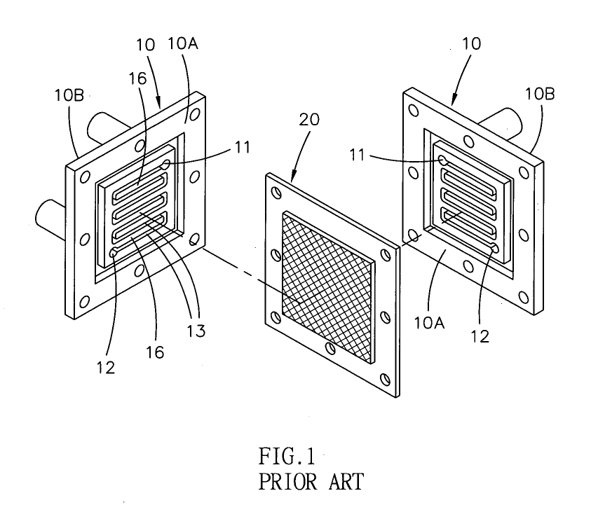

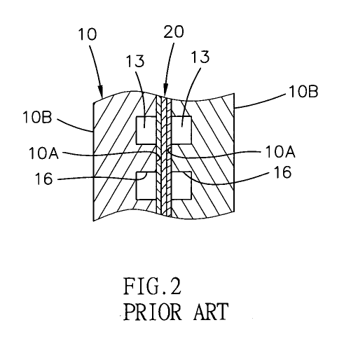

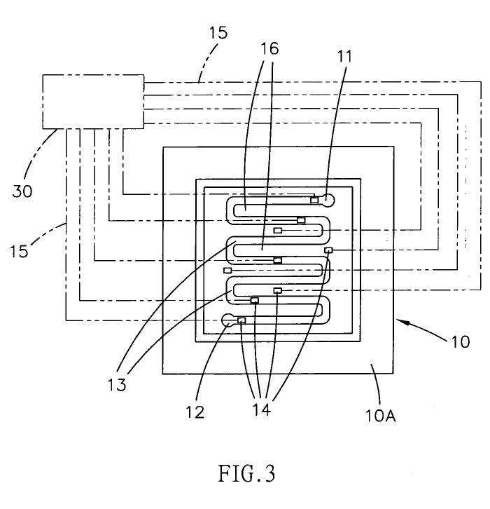

Referring to FIGS. 1 to 3, the present invention is a fuel cell having micro sensors. It mainly comprises a pair of bipolar plates 10 and a catalytic portion 20. Concerning the pair of bipolar plates 10, each bipolar plate 10 has an inner surface 10A and an outer surface 10B. The inner surface 10A is disposed with
(a) a fluid inlet 11;
(b) a fluid outlet 12;
(c) a channel 13 connecting the fluid inlet 11 and the fluid outlet 12;
(d) at least one sensor 14; and
(e) at least one signal line 15 corresponding to the sensor(s) 14.

About this catalytic portion 20, it is positioned between the bipolar plates 10.

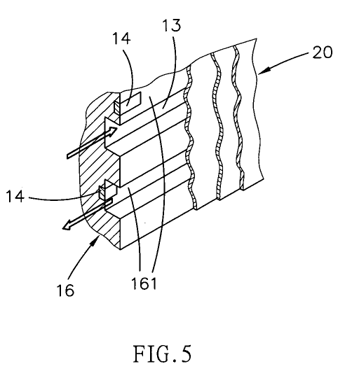

In fact, this channel 13 is curvy and surrounded by many blocking portions 16. Each blocking portion 16 contains an upper surface 161 (as shown in FIG. 5) that contacts the catalytic portion 20. One or more micro sensors 14 are disposed on the upper surface 161 of the blocking portion(s) 16. Also, by using the corresponding signal line(s) 16, the detected signals from the sensor(s) 14 will be connected to a controller 30 outside.

Usually the fuel cell can be stacked together as a stacked configuration of fuel cell laminates so as to generate more electricity. During the electricity generating process, some fluid (such as water) and heat (causing high temperature) are generated. Because there are many micro sensors 14 disposed on some (or all) blocking portions 16 and on the inner surface 10A. They can detect the actual conditions of the fluid generated and detect the temperature distribution inside the fuel cell. All these detected signals are linked to the controller 30 outside the fuel cell.

Once the controller 30 receives an abnormal signal (such as the produced water is too much or the temperature is too high, etc.), it can control the pressure (such as reducing the pressure) or property of the supplying fuel gases (H₂ and O₂) in order to solve the problem detected.

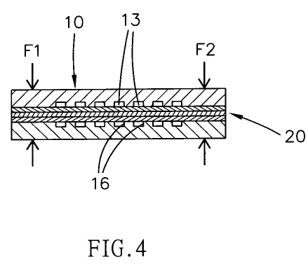

As illustrated in FIG. 4, the fuel cell is assembled by two bipolar plates 10 and becomes one firmly locked structure (assuming there two locking forces F1 and F2). During such locking process, some of the micro sensors 14 can detect the locking forces F1 and F2. Then, the detected information will be sent to the controller 30. If the locking forces F1 and F2 are too large or not even, it might cause the deformation of the fuel cell or influence the electricity generating efficiency.

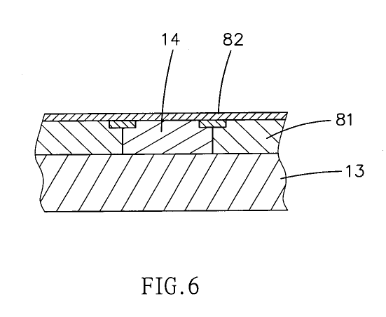

As shown in FIG. 6, the micro sensor 14 is installed beside the channel 13 (or on the blocking portion 16). In addition, a first securing element 81 (only when it will not influence the function of the micro sensor) can be disposed beside the micro sensor 14. Also, this micro sensor 14 is covered by a second securing element 82 (only when it will not influence the function of the micro sensor 14). By doing so, the micro sensor 14 will not protruded out in the channel 13 (or on the blocking portion 16). Therefore, such securing or mounting design will not influence the flowing field in the channel nor reduce the electricity generating function.

The advantages and functions of the present invention can be summarized as follows:

[1]. It can detect the actual internal conditions in the fuel cell. In this invention, these micro sensors are mounted or embedded in suitable positions contact (or near) the channel's surface or on the blocking portions. So, it can precisely detect the actual temperature, humidity, gas pressure and other related information at specific points in the channel. By analyzing the detected data, when the function of this fuel cell is abnormal, the operator will know it. Furthermore, the gas pressure or humidity can be immediately adjusted (for example increasing or decreasing) so that the entire fuel cell will work fine.

[2] There is no need to install extra micro sensors. When the bipolar plates are manufactured in a factory, all these micro sensors are embedded or mounted on (or near) the channel's surface or on the blocking portions. In addition, the first securing element and the second securing element can be covered, if needed. Hence, these micro sensors will not protrude out to interfere the flow field in the channel. Also, these micro sensors are integral with the bipolar plates. Therefore, these micro sensors will not influence the flowing rate or flowing speed.

[3] The fuel cell stability and safety can be enhanced significantly. Not only these micro sensors can detect the current conditions inside the fuel cell, but also the invention can feed back proper commands to adjust the pressure of the supplying gas, the humidity of supplying gas or the like. Thus, during the normal operation, this invention can quickly react or make an optimal adjustment at the right timing to avoid any possible dangerous or undesired conditions. So, its stability and safety are enhanced significantly.

The above embodiments are only used to illustrate the present invention, not intended to limit the scope thereof. Many modifications of the above embodiments can be made without departing from the spirit of the present invention.

What is claimed is:

1. A fuel cell having micro sensors comprising:
a pair of bipolar plates, each bipolar plate having an inner surface and an outer surface, said inner surface being disposed with a fluid inlet, a fluid outlet, a channel connecting said fluid inlet and said fluid outlet, at least one sensor, and at least one signal line; and
a catalytic portion between said bipolar plates.

2. The fuel cell having micro sensors as claimed in claim 1, wherein said channel is curvy and surrounded by several blocking portions, each blocking portion having an upper surface that contact the catalytic portion; and, at least one micro sensor being disposed on said upper surface of said blocking portion.

3. The fuel cell having micro sensors as claimed in claim 1, wherein at least one micro sensor being disposed on said inner surface and contacting said channel.

4. The fuel cell having micro sensors as claimed in claim 1, further comprising:
a controller for receiving corresponding signal of said at least one sensor so as to control the fuel cell.
